(19) United States
(12) Patent Application Publication
(10) Pub. No.: US 2013/0144590 A1
(43) Pub. Date: Jun. 6, 2013

(54) CONFIGURATION MANAGEMENT

(71) Applicants: Mathias Salle, San Francisco, CA (US); Erik L. Eidt, Campbell, CA (US)

(72) Inventors: Mathias Salle, San Francisco, CA (US); Erik L. Eidt, Campbell, CA (US)

(21) Appl. No.: 13/812,578

(22) PCT Filed: Jul. 30, 2010
(86) PCT No.: PCT/US2010/043910

§ 371 Date: Jan. 28, 2013

(51) Int. Cl. G06F 17/50

(52) U.S. Cl. CPC G06F 17/509
USPC 703/21

(57) ABSTRACT

A configuration management method and system include storing a first model definition, storing a first instance of the first model, receiving an operator and modifying the first instance of the first model based on the received operator. The modified first instance of the first model is then stored.

### BACKGROUND

During the lifecycle of an information technology (IT) service, changes often occur. Those changes can range from reconfiguration of service attributes to upgrade and downgrade, as well as migration, scale out, etc. Typically, these changes are accomplished manually, resulting in unsatisfactory repeatability, speed of execution, cost efficiency, etc.

Known solutions focus on manually approving and scheduling changes as well as determining conflicting changes between concurrent changes. The Information Technology Infrastructure Library (ITIL) provides a framework for service support. A configuration management is an example of the service support. The configuration management refers to a process for recognizing a configuration item targeted for IT service management to keep, update, confirm, and audit information about the configuration item. The configuration item represents resources targeted for configuration. The configuration item includes not only system resources inclusive of hardware and software but also facilities necessary for providing an IT service, documents such as a description about how to provide IT services, an operating procedure, and a diagram, hardware or software maintenance services, processes, etc.

The IT Infrastructure Library (ITIL) based framework focus heavily on the change process but not on the changes themselves. Systems that focus on changes create wrappers (tasks, etc) that end up being implemented by humans (administrators, etc).

### BRIEF DESCRIPTION OF THE DRAWINGS

FIG. 1 is a block diagram conceptually illustrating an example of a computer system.

FIG. 2 is a block diagram conceptually illustrating aspects of an example of a configuration management system (CMS).

FIG. 3 is a graphic representation of an example of a model.

FIG. 4 is a graphic representation of an example of another model.

FIG. 5 is a graphic representation of the example model of FIG. 4 modified in response to a received operator.

FIG. 6 is a graphic representation of the example model of FIG. 5 modified in response to a received operator.

FIGS. 7 and 8 illustrate an example of an operation used to upgrade a two tier application.

### DETAILED DESCRIPTION

In the following detailed description, reference is made to the accompanying drawings which form a part hereof, and in which is shown by way of illustration specific implementations. It is to be understood that other implementations may be utilized and structural or logical changes may be made without departing from the scope of the present disclosure. The following detailed description, therefore, is not to be taken in a limiting sense, and the scope of this disclosure is defined by the appended claims.

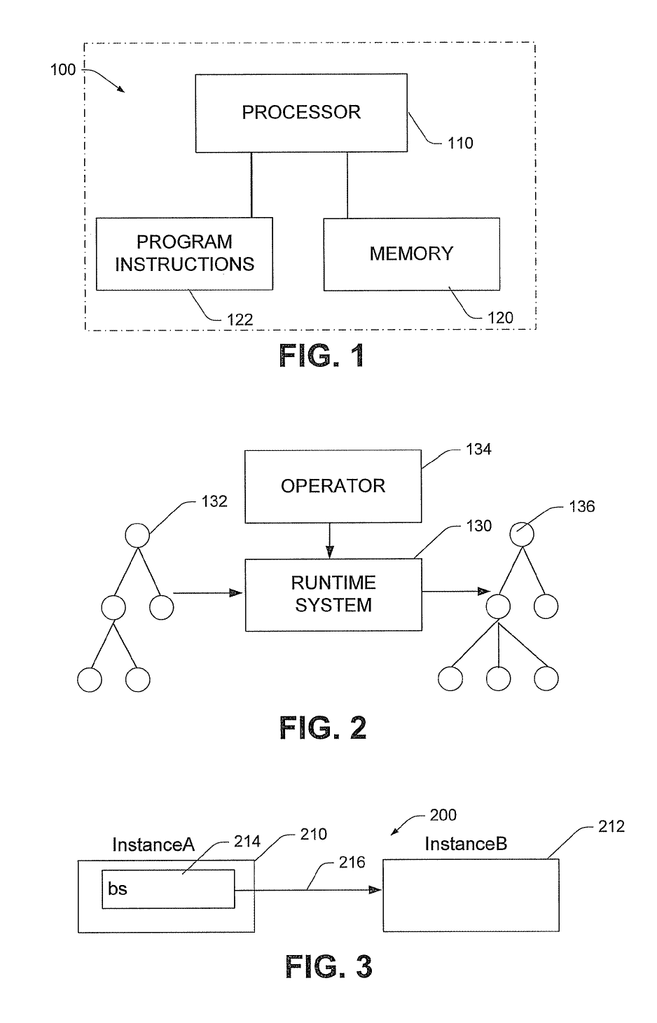

Among other things, an example of a Configuration Management Service (CMS) is disclosed that includes a set of operations used to dynamically modify the structure of IT service instances. FIG. 1 illustrates a block diagram of a computer system 100 implementing an example of a CMS. The computer system 100 includes a processor 110 coupled to a memory 120. The memory 120 can be operable to store program instructions 122 that are executable by the processor 110 to perform one or more functions. It should be understood that “computer system” can be intended to encompass any device having a processor that can be capable of executing program instructions from a memory medium. For example, the various functions, processes, methods, and operations of the CMS implementations described herein may be implemented using the computer system 100.

The various functions, processes, methods, and operations performed or executed by the system 100 can be implemented as the program instructions 122 (also referred to as software or simply programs) that are executable by the processor 110 and various types of computer processors, controllers, central processing units, microprocessors, digital signal processors, state machines, programmable logic arrays, and the like. In some implementations, the computer system 100 may be networked (using wired or wireless networks) with other computer systems, and the various components of the system 100 may be local to the processor 110 or coupled thereto via a network.

In various implementations, the program instructions 122 may be stored on the memory 120 or any non-transient computer-readable medium for use by or in connection with any computer-related system or method. A computer-readable medium can be an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type.

FIG. 2 conceptually illustrates aspects of an example CMS in accordance with disclosed implementations. The CMS includes an operator runtime system 130 implemented by the computer system 100. A service instance 132 and an operator 134 compose the system inputs. The output is a changed service instance 136. The operator runtime system 130 schedules and applies the invoked operation in order to change dynamically the inputted service instance 136.

A service as used herein generally refers a utility or benefit provided by a provider to a consumer. The provider and the consumer may vary by application and may include an enterprise, a business unit, a business process, an application, a third party, an individual, and similar others. Enterprise services may be provided in the course of conducting the enterprise business. IT services generally refer to any application that enables the enterprise to provide utility or benefit by adding functionality to the IT infrastructure.

A model as used herein generally refers to a representation of the design, characteristics and behavior of a system, element, solution, or service. The model can be a declarative specification of structural, functional, non-functional, runtime characteristics, etc. of an IT system, element, solution, service, etc. The instantiation of a model creates a model instance, which is stored as a representation of the model in memory, such as the memory 120. Additionally, an artifact representing the model instance is created in the datacenter.

The model captures the design of a particular IT element or solution, e.g., IT services captured as a service model, defining the externally visible description, behavior, state, and operations available from a service to other services. Thus, the instantiation of a model results in a generation of a virtual runtime object, e.g., the model instance, and also results in a generation of a real, tangible IT artifact in an IT infrastructure, which, for example, could be a data center that includes hardware, software, communications, applications, services and similar other components to provide IT functions.

Consider a model A defined as follows:

```
Public Model A{
      import b is B;
      variable bs is b;
      self depends on bs with cardinality [1..3];
}
```

Where B is a model, b is a custom type based on B's default variations. bs is a variable of type b that can hold from 1 to 3 references to instances of b, with an initial value of 1. The model definition is stored in the memory 120. Suppose that a first instance of A is created and stored in the memory 120. FIG. 3 illustrates a graphic representation 200 of this model. In accordance with disclosed implementations of the CMS 100, the first instance of the model is modified based on the received operator 134, and the modified first instance is stored in the memory 120. As illustrated in FIG. 3, two instances would be created in the CMS 100 and stored in the memory 120: an instance of model A, instanceA 210, and an instance of model B, instanceB 212. The variable bs 214 in instanceA 210 contains a reference 216 to InstanceB 212.

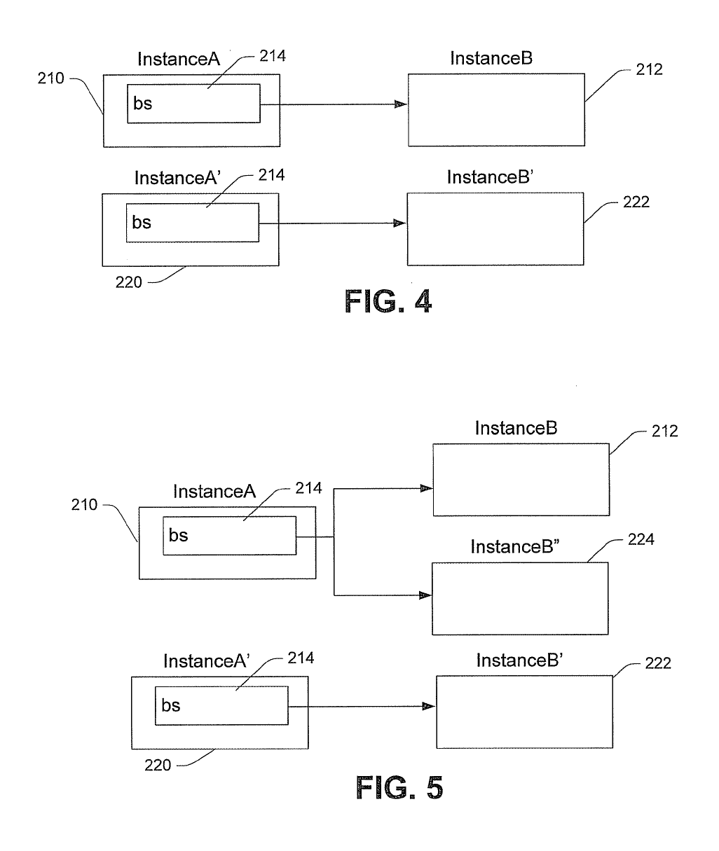

FIG. 4 illustrates a situation where another instance of A, InstanceA′ 220 is created, with the variable bs 214 in instanceA′ 220 containing a reference to a corresponding instance of model B, instanceB′ 222.

In some implementations, the operator runtime system 130 of the CMS 100 receives the operator 134 in the form of operators of modularity, which are statements or commands used, for example, to modify existing instances by inserting, excluding or substituting instances.

For example, the variable bs 214 in model A 210 can admit 1, 2 or 3 instances of B 212. Suppose it was desired to insert a new instance of B in the existing instanceA 210, for example, to improve the performance of an IT system. InstanceA 210 is called the target instance, bs 214 the modularity point and in this case the inserting point. The following operation is invoked and received by the runtime system 130:
insert(instanceA, bs, B)

FIG. 5 illustrates the resulting model instances. This operation would first create a new instance of B, instanceB″ 224, and would then insert the newly created instance reference in the variable bs 214 of instanceA 214. Thus, the variable bs 214 of InstanceA 214 contains a reference to both InstanceB 212 and InstanceB″ 224, with the variable bs 214 of InstanceA′ 220 containing a reference to InstanceB′ 222.

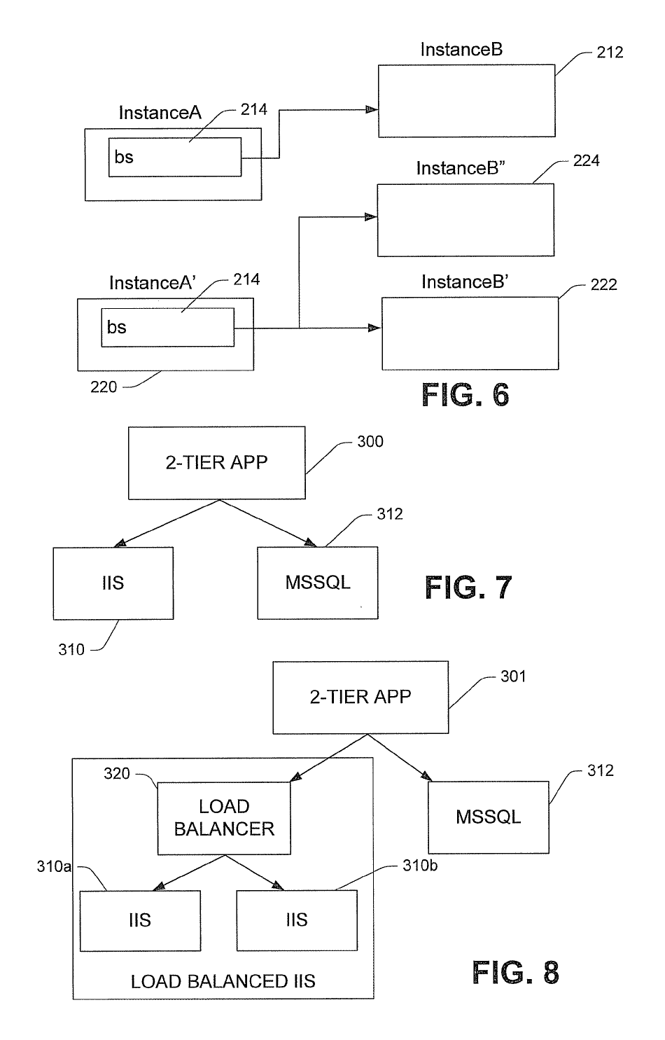

If instanceB″ 224 were to be inserted into variable bs 214 of instanceA′ 220, instanceB″ 224 would first need to be excluded, or removed, from instanceA 214 since InstanceB″ should belong to only one instance at a time. InstanceB″ is then inserted into instanceA′ 220. This arrangement is illustrated in FIG. 6. The following operations are invoked and received by the runtime system 130 to accomplish this:

exclude(instanceA, bs, instanceB″)
insert(instanceA′,bs,instanceB″)

In the illustrated implementations, if
exclude(instanceA, bs, instanceB)
   were invoked, the operation would not be successful as the variable bs is defined with a [1.3] cardinality, which would be violated if instanceB were removed.

This example could represent moving a webserver from one load balancer to another. This could be done in a context where InstanceA and InstanceA′ are actually both part of a larger service. In effect, this is a dynamic readjustment of resources. If instanceA and instanceA′ belong to different customers or accounts, however, instance B″ might need to be cleaned or rebooted first. In another example, instanceB″ could be broken down and reassembled into another configuration before being transferred to instanceA′; thus this would represent transferring underlying compute or other resources using a similar exclude/insert sequence, though with more reconfiguration in between.

Several different operations are employed by various implementations of the CMS. For example, the insertInstance and excludeInstance are CMS operations that allow the manipulation of model instances at a very low level. Those operations may be called through higher level operations rather than being called directly. The insertInstance operation is responsible for inserting an existing instance into a modularity point of a given target instance. The form of the insertInstance operation is as follows:

insertInstance(ModelInstance target, Reference mp,
ModelInstance instance)

The behavior of this may operation differ based on the type of the target. If the target is a Pooled Model, the operation may take care of the management of the pool counters, whereas for regular and shared models it may not.

The excludeInstance operation is responsible for removing an existing instance from a modularity point of a given target instance. Its form is

excludeInstance(ModelInstance target, Reference mp,
ModelInstance instance)

The behavior of this operation differs based on the type of the target. If the target is a PooledModel, the operation may take care of the management of the pool counters, whereas for regular and shared models it may not.

The insert operation is responsible for inserting an instance, either existing or to be created, into a modularity point of a given target instance. Its form is

```
      insert(ModelInstance target, Reference mp,
ModelInstance instance)
      insert(ModelInstance target, Reference mp, Model
model, OptionSelection op)
```

Although similar to the insertInstance operation from a signature point of view, the insert operation differs in its implemented behavior.

```
      insert(ModelInstance target, Reference mp,
ModelInstance instance){
      insertInstance(target,mp,instance); [This changes the in-
memory representation]
      configure(target); [This reconfigures the target model and as it
does so, picks up the changes made to the in-memory model and performs
changes in the data center]
}
```

As specified above, the insert operation uses the insertInstance operation to create the relationships between the instances in the CMS. Finally, it invokes a configuration (reconfiguration) of the target model.

For example, if a new web server were to be added to a load balancer, the following operation may be invoked:

insert (loadBalancerI_1, webServers, webServerI_23) where loadBalancerI_1 denotes the instance of the load balancer, webServers is the modularity point in that instance and webServerI_23 is the instance of the web server to insert.

The operation may first establish the new relationship is the CMS and it may then invoke
configure(loadBalancerI_1)
   which will configure the load balancer with the new web server.

If it is desired to insert a new instance rather than an existing one, the following is invoked:

```
      insert(ModelInstance target, Reference mp, Model
model, OptionSelection op){
      instance = create(model,op);
      insertInstance(target,mp,instance);
      configure(target);
      }
```

The exclude operation is responsible for removing an instance from a modularity point of a given target instance. An exclusion can be definitive or partial. In a definitive exclusion, the relationships between instances are removed and the excluded instance is terminated, whereas in a partial exclusion, the instances is not terminated.

```
exclude(ModelInstance target, Reference mp, ModelInstance
      instance,ExclMod m){
      excludeInstance(target,mp,instance);
      configure(target);
      if m == “definite” terminate(instance);
}
```

The substitute operation is responsible for replacing an instance of a model with a compatible instance, existing or to be created.

```
substitute(ModelInstance target, Reference mp,
ModelInstance instance, ModelInstance substitute){
      exclude(target,mp,instance);
      insert(target,mp,substitute);
}
substitute(ModelInstance target, Reference mp,
ModelInstance instance, Model model, OptionSelection op){
      exclude(target,mp,instance);
      insert(target,mp,model,op);
}
```

During substitution, type compatibility between the instance to be substituted and the substitute instance may be checked. It may be a fatal error if the types do not match.

The root substitute operation is used to substitute a root model. It may be similar in essence to the substitute operation only no references are provided since the root model is completely substituted. This operation may be useful when it is desired to reuse the identity of a service (it may be known to a customer) but wholly change its implementation.

The Porting operation is used to change the underlying structure of an instance. For instance, if a web server has initially been instantiated on a Linux operating system. Assume that for some specific reason it is desired to move that web server to a WindowsServer operating system. This may be a fairly delicate operation because it involves creating the new instance WebServer->WindowsServer and then substituting the old instance with that new one.

FIGS. 7 and 8 illustrate an example where the use of the substitute operation is used to upgrade a two tier application. The service models include a two-tier application with a web server and a database. FIG. 7 illustrates the current service instance 300, where in its initial ordered configuration, the two tier application is designed with a single Internet Information Services (IIS) web server 310 and a Microsoft SQL Server (MSSQL) 312 corresponding to a standard performance level. The objective of the upgrade may be to change to a high performance level, which is achieved in this scenario by substituting the single web server with a load balanced tier of web servers. The new service instance 301 is illustrated in FIG. 8, where the IIS server 310 has been replaced by a load balancer 320 and two IIS servers 310a and 310b at a high performance level. As herein, the substitute operation builds on the insert, create, configure and exclude operation to first create the load balanced web servers, then exclude the single web server, and then insert the newly created load balanced web servers.

Although specific implementations have been illustrated and described herein, it will be appreciated by those of ordinary skill in the art that a variety of alternate and/or equivalent implementations may be substituted for the specific implementations shown and described without departing from the scope of the present disclosure. This application is intended to cover any adaptations or variations of the specific implementations discussed herein. Therefore, it is intended that this disclosure be limited only by the claims and the equivalents thereof.

What is claimed is:

1. A configuration management method, comprising:
storing a first model definition specifying characteristics of an IT system;
storing a first instance of the first model;
receiving an operator;
modifying the first instance of the first model based on the received operator; and
storing the modified first instance of the first model.

2. The configuration management method of claim 1, further comprising:
storing a first instance of a second model.

3. The configuration management method of claim 2, further comprising:
inserting the first instance of the second model in a variable of the first instance of the first model.

4. The configuration management method of claim 3, further comprising:
creating a second instance of the first model;
inserting a second instance of the second model in a variable of the second instance of the second model.

5. The configuration management method of claim 4, wherein:
receiving the operator includes receiving an insert operator; and
modifying the first instance of the first model includes inserting a third instance of the second model in the variable of the first instance of the first model.

6. The configuration management method of claim 5, wherein:
receiving the operator includes receiving an exclude operator; and
modifying the first instance of the first model includes removing the third instance of the second model from the variable of the first instance of the first model.

7. The configuration management method of claim 5, wherein:
receiving the operator includes receiving an insert operator; and
wherein modifying the first instance of the first model includes inserting the third instance of the second model in the variable of the second instance of the first model.

8. A configuration management system, comprising:
a memory storing a first model definition specifying characteristics of an IT system, and a first instance of the first model;
a runtime system configured to receive an operator, modify the first instance of the first model based on the received operator, and store the modified first instance of the first model in the memory.

9. The configuration management system of claim 8, wherein a first instance of a second model is stored in the memory.

10. The configuration management system of claim 9, wherein the runtime system is configured to insert the first instance of the second model in a variable of the first instance of the first model.

11. The configuration management system of claim 10, wherein the runtime system is configured to create a second instance of the first model, and insert a second instance of the second model in a variable of the second instance of the second model.

12. The configuration management system of claim 11, wherein the received operator includes an insert operator, and wherein the runtime system is configured to insert a third instance of the second model in the variable of the first instance of the first model in response to the operator.

13. The configuration management system of claim 12, wherein the received operator includes an exclude operator, and wherein the runtime system is configured to remove the third instance of the second model from the variable of the first instance of the first model in response to the operator.

14. The configuration management system of claim 12, wherein the runtime system is configured to insert the third instance of the second model in the variable of the second instance of the first model.

15. A configuration management method, comprising:
storing a model defining a two tier application;
storing a first instance of the first model including a single web server and a database;
receiving a substitute operator;
modifying the first instance of the first model by substituting a load balanced tier of web servers for the single web server; and
storing the modified first instance of the first model.
